(19) United States
(12) Patent Application Publication
(10) Pub. No.: US 2024/0403888 A1
(43) Pub. Date: Dec. 5, 2024

(54) INFORMATION PROCESSING APPARATUS, INFORMATION PROCESSING SYSTEM, INFORMATION PROCESSING METHOD, AND STORAGE MEDIUM

(71) Applicant: NEC Corporation, Tokyo (JP)

(72) Inventor: Shinya TAKAHASHI, Tokyo (JP)

(73) Assignee: NEC Corporation, Tokyo (JP)

(21) Appl. No.: 18/675,250

(22) Filed: May 28, 2024

(30) Foreign Application Priority Data
May 29, 2023 (JP) 2023-088091

(51) Int. Cl. G06Q 30/01

(52) U.S. Cl. CPC G06Q 30/01

(57) ABSTRACT

Provided is a technique to present an additional service related to a service which a user has received so as to reduce an amount of information presented to the user and easily obtain agreement from the user to use user data. An information processing apparatus includes: an acquisition means for acquiring user data pertaining to a service which a user has received from an operator; a determination means for determining whether or not there is a value-added service receivable from a second operator in relation to the service; and a generation means for generating a message in a case where the value-added service has been determined to exist, the message including (i) an agreement request for provision of the user data possessed by the operator to the second operator and (ii) information pertaining to the value-added service which is receivable upon approval of the user to the agreement request.

This Nonprovisional application claims priority under 35 U.S.C. § 119 on Patent Application No. 2023-088091 filed in Japan on May 29, 2023, the entire contents of which are hereby incorporated by reference.

### TECHNICAL FIELD

The present invention relates to an information processing apparatus, an information processing system, an information processing method, and a storage medium.

### BACKGROUND ART

In a case where, for example, a user has used a service of an operator, user data (hereinafter, referred to also as “UD”) pertaining to the use of the service is generated and is retained by the operator that provides the service. If it is possible to share the UD with a second operator that constructs a touch point (which is a place where a user can use a service of the second operator) along a flow line of the user, it is possible to differentiate services that are provided to the user between an operator group that carries out user data coordination and an operator group that does not carry out user data coordination. In order to facilitate user data coordination, it may be considered that agreement on UD distribution is obtained in advance from a user, who is the owner of the UD, at a timing such as the time of member registration or the time of user information (ID) coordination registration, and the UD is left in a distributable state. However, at present, there is a problem that agreement of the user, who is the owner of the UD, on data coordination is not easily obtained, and the data coordination is not facilitated.

Reasons for difficulty in obtaining agreement of the user on data coordination may be as follows. First, there are many rules and regulations for the user to make agreement. It is considered that understanding of such rules and regulations is burdensome, and the user will not agree with data coordination. Moreover, the user may be concerned about the following case: that is, if the user makes agreement without careful consideration, the operator takes the initiative in data coordination, and unintended UD distribution would be carried out. If such a result is actually brought about, concern of an increase in reputation risk (i.e., a risk that the credit of the operator is impaired) occurs. That is, if understanding by the user about rules and regulations related to agreement on data coordination is insufficient or data coordination by the operator is in an unintended mode for the user, the user would distrust the data coordination even with the agreement. Such a case leads to a risk that the user ultimately cancels or secedes from the data coordination, and a tendency to avoidance occurs with respect to the entire UD distribution market by data coordination.

Patent Literature 1 discloses a data management apparatus including: an estimation section that estimates a data item for which a user easily agrees with data distribution or service coordination pertaining to a service item with which the user easily agrees; a recommendation section that recommends the data item which the estimation section has estimated to be easily agreed or the service coordination pertaining to the service item which the estimation section has estimated to be easily agreed by causing a terminal of the user to display the data item or service coordination; and the like. It is described that such an apparatus makes it possible to manage data of a user and recommend the user to provide the data to an operator that uses the data.

Patent Literature 2 discloses a user agreement management apparatus including: a risk evaluation section that calculates a risk of a user based on a utilization level corresponding to a service obtained from the user and content of personal data; a profit evaluation section that calculates profit which the user can receive based on the utilization level corresponding to a service obtained from the user; and the like. It is described that, according to the apparatus, an individual can select a granularity of information with which utilization is to be agreed, while the individual ascertains profit and risk corresponding to the granularity of information to be utilized.

### CITATION LIST

### Patent Literature

### [Patent Literature 1]

PCT International Publication No. WO2022/185471

### [Patent Literature 2]

Japanese Patent Application Publication, Tokukai, No. 2015-141642

### SUMMARY OF INVENTION

### Technical Problem

However, in the data management apparatus disclosed in Patent Literature 1, a user is made to carry out selections from a large number of presented service items to be agreed. Therefore, there is a risk that determination as to whether or not to agree cannot be easily made. In the user agreement management apparatus disclosed in Patent Literature 2, there is a risk that, if there are many options for the granularity of information to be agreed for utilization, it would be difficult for the user to determine an extent of information to be agreed for utilization. In such a case where the user has difficulty in the determination, it is highly likely that the user will not make agreement.

An example aspect of the present invention is accomplished in view of the above problems, and an example object thereof is to provide a technique which makes it easy to obtain agreement from a user to use user data.

### Solution to Problem

An information processing apparatus in accordance with an example aspect of the present invention includes at least one processor, the at least one processor carrying out: an acquisition process of acquiring user data pertaining to a service which a user has received from an operator; a determination process of determining whether or not there is a value-added service which is receivable from a second operator in relation to the service; and a generation process of generating a message in a case where it has been determined that there is the value-added service, the message including (i) an agreement request for provision of the user data possessed by the operator to the second operator and (ii) information pertaining to the value-added service which is receivable upon approval of the user to the agreement request.

An information processing method in accordance with an example aspect of the present invention includes: acquiring, by at least one processor, user data pertaining to a service which a user has received from an operator; determining, by the at least one processor, whether or not there is a value-added service which is receivable from a second operator in relation to the service; and generating, by the at least one processor, a message in a case where it has been determined that there is the value-added service, the message including (i) an agreement request for provision of the user data possessed by the operator to the second operator and (ii) information pertaining to the value-added service which is receivable upon approval of the user to the agreement request.

An information processing system in accordance with an example aspect of the present invention includes at least one processor and a memory, the at least one processor carrying out: an acquisition process of acquiring user data pertaining to a service which a user has received from an operator; a determination process of determining whether or not there is a value-added service which is receivable from a second operator in relation to the service; and a generation process of generating a message in a case where it has been determined that there is the value-added service, the message including (i) an agreement request for provision of the user data possessed by the operator to the second operator and (ii) information pertaining to the value-added service which is receivable upon approval of the user to the agreement request, and the memory storing a value-added service table in which information pertaining to the operator, information pertaining to the value-added service, information pertaining to the second operator that provides the value-added service, and information pertaining to provision user data to be provided to the second operator are recorded in association with each other.

A storage medium in accordance with an example aspect of the present invention is a computer-readable non-transitory storage medium storing a program for causing at least one processor to carry out the above information processing method.

### Advantageous Effects of Invention

According to an example aspect of the present invention, an additional service related to a service which a user has received is presented, and it is thus possible to reduce an amount of information presented to the user and easily obtain agreement from the user to use user data.

### BRIEF DESCRIPTION OF DRAWINGS

FIG. 1 is a block diagram illustrating a configuration of an information processing apparatus 1 in accordance with a first example embodiment of the present invention.

FIG. 2 is a flowchart illustrating a flow of an information processing method in accordance with the first example embodiment.

FIG. 3 is a block diagram illustrating a configuration of an information processing system 2 in accordance with the first example embodiment.

FIG. 4 is a schematic diagram illustrating a flow of an added value provision service and content of steps which are carried out by the information processing apparatus 1.

FIG. 5 is a schematic diagram illustrating content of various kinds of tables stored in a storage section of the information processing apparatus 1.

FIG. 6 is a schematic diagram illustrating a procedure for generating a message by a generation section and an example of the message.

FIG. 7 is a block diagram illustrating a configuration of an information processing apparatus 1A in accordance with a second example embodiment of the present invention.

FIG. 8 is a schematic diagram illustrating a flow of an added value provision service and content of steps which are carried out by the information processing apparatus 1A.

FIG. 9 is a block illustrating a configuration of an information processing system 2A in accordance with the second example embodiment.

FIG. 10 is a configuration diagram for realizing an information processing apparatus by software.

### EXAMPLE EMBODIMENTS

### First Example Embodiment

The following description will discuss a first example embodiment of the present invention in detail, with reference to the drawings. The present example embodiment is a basic form of example embodiments described later.

### Configuration of Information Processing Apparatus 1

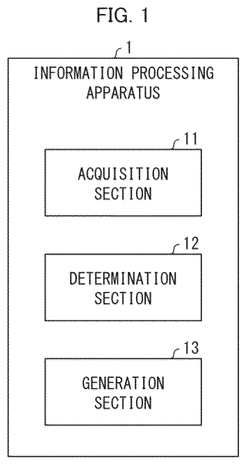

The following description will discuss a configuration of an information processing apparatus 1 in accordance with the present example embodiment, with reference to FIG. 1. FIG. 1 is a block diagram illustrating a configuration of the information processing apparatus 1. As illustrated in FIG. 1, the information processing apparatus 1 includes an acquisition section 11, a determination section 12, and a generation section 13.

In a case where a user has carried out an economic action, the information processing apparatus 1 presents a value-added service which is receivable in relation to the economic action. The information processing apparatus 1 also asks for agreement to provide user data of the economic action to another service operator (hereinafter, this operation is referred to also as “data coordination”). For example, the information processing apparatus 1 is administrated by an administrator who aims to facilitate economic vitalization in a certain region by stimulating economic activities of users (consumers) in the certain region. The administrator that administrates the information processing apparatus 1 makes contracts with a plurality of service operators in advance for provision of data of a service which a user has received from a certain service operator to another service operator.

Hereinafter, the “service operator” is simply referred to as “operator”.

The acquisition section 11 acquires user data pertaining to a service which a user has received from an operator. The term “service” means provision to a large number of unspecified users by an operator, including sale of articles, provision of meals, provision of various kinds of facilities such as transportation facilities, recreational facilities, and lending facilities. The phrase “receive a service” means that a user uses (economic action) a service provided by the operator, such as purchase of articles, eating and drinking at restaurants, and use of various kinds of facilities (such as transportation facilities, recreational facilities, and lending facilities). The aspect in which the user uses the service varies in accordance with types of services. The term “operator” indicates a profit organization or a nonprofit organization that provides the above service to a user. Note that the above service is not limited to paid services, and may be unpaid services. The acquisition section 11 is an example aspect of the acquisition means recited in claims.

The “user data” is information indicating specific content of the above service which the user has used. For example, in a case where a user has done shopping using various kinds of cards at a supermarket, information pertaining to the user, as well as purchased articles and prices thereof are stored, for example, a point of sale (POS) terminal at the supermarket. The POS terminal is a terminal that has a function of payment for purchase and a function to generate purchase information (user data) thereof. The acquisition section 11 acquires this user data from the POS terminal.

The determination section 12 determines whether or not there is a value-added service which is receivable by the user from a second operator in relation to the service which the user has received. The term “value-added service” refers to a secondary service that is related to a service (also referred to as a primary service) which user has received, and that is considered to have utility value (added value) for the user, that is, considered to be favorable for the user. The determination section 12 is an example aspect of the determination means recited in claims.

For example, a value-added service related to shopping at a supermarket can be considered to be guidance to coin lockers available nearby, arrangements for taxi dispatch, provision of various coupons, and the like. For example, a user who has increased belongings due to shopping can temporarily deposit the belongings or return home by taxi thanks to guidance to the coin locker or dispatch of the taxi. By reception of presentation of information in a timely manner, it is possible to increase a feeling of satisfaction of the user. The various kinds of coupons obtained by the primary service are economic benefits that can be received only when the user has received the primary service, and a feeling of satisfaction of the user can be increased. That is, the value-added service is a service which can increase a feeling of satisfaction of the user when the user receives such a value-added service in association with the primary service. Note that a tertiary service which can be received by receiving the secondary service, a quaternary service, and the like are also value-added services.

The information processing apparatus 1 can include a storage section that stores information pertaining to a value-added service. For example, information pertaining to a value-added service is information associated with a supermarket used by the user, such as information of coin lockers near the supermarket, information of a nearby taxi company, and coupon information or menu recipe information of a nearby restaurant.

In a case where the determination section 12 has determined that there is such a value-added service, the generation section 13 generates a message including (i) an agreement request for provision of user data possessed by the operator to the second operator and (ii) information pertaining to the value-added service which is receivable upon approval of the user to the agreement request. Hereinafter, the phrase “approve an agreement request” is also referred to simply as “agree”. The generation section 13 is an example aspect of the generation means recited in claims.

The message generated by the generation from the information section 13 is transmitted processing apparatus 1 to a terminal apparatus (such as a smart phone) of the user. The user replies to the message for indicating whether or not to agree to provide user data as own shopping data to the operator of the coin locker, or to the taxi company, or to the operator of the restaurant. Then, in a case where the user has agreed to provide the user data to the second operators, an invitation to a secondary service is delivered from each of the operators to a mobile terminal of the user. Then, the user can easily use the secondary service as intended, and therefore the user can obtain a feeling of satisfaction.

### Example Advantage of Information Processing Apparatus 1

As described above, the information processing apparatus 1 in accordance with the first example embodiment employs the configuration of including: the acquisition section 11 for acquiring user data pertaining to a service which a user has received from a certain operator; the determination section 12 for determining whether or not there is a value-added service which is receivable by the user from a second operator in relation to the service which the user has received; and the generation section 13 for generating a message in a case where it has been determined by the determination section 12 that there is such a value-added service, the message including (i) an agreement request for provision of the user data possessed by the certain operator to the second operator and (ii) information pertaining to the value-added service which is receivable upon approval of the user to the agreement request. In such a configuration, only a value-added service which would be favorable for the user, is timely, and is related to the primary service which the user has received is searched and presented to the user. Therefore, content of coordinated user data and the number of second operators carrying out data coordination are restricted, and an amount of information presented to the user can be reduced. Therefore, according to the information processing apparatus 1 in accordance with the first example embodiment, an additional service related to a service which a user has received is presented, and it is thus possible to bring about an example advantage of reducing an amount of information presented to the user and easily obtaining agreement from the user to use user data.

### Flow of Information Processing Method

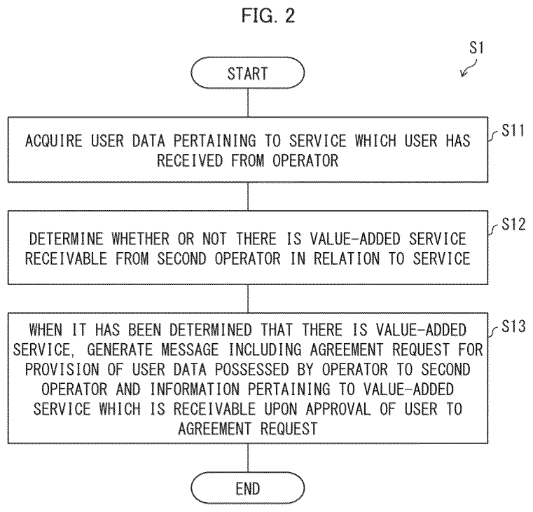

Next, the following description will discuss an information processing method S1 in accordance with the first example embodiment, with reference to the drawings. FIG. 2 is a flowchart illustrating a flow of the information processing method S1. As illustrated in FIG. 2, the information processing method S1 includes step S11 through step S13.

In step S11, the acquisition section 11 acquires user data pertaining to a service which a user has received from a certain operator. The meanings of “operator”, “service” and “user data” are as described above.

In step S12, the determination section 12 determines whether or not there is a value-added service which can be received from a second operator in relation to the service. The meaning of “value-added service” is as described above.

In a case where it has been determined that there is the value-added service, in step S13, the generation section 13 generates a message including (i) an agreement request for provision of the user data possessed by the operator to the second operator and (ii) information pertaining to the value-added service which is receivable upon approval of the user to the agreement request. The generated message is transmitted from the information processing apparatus 1 to a mobile terminal or the like of the user.

### Example Advantage of Information Processing Method S1

As described above, the information processing method S1 in accordance with the first example embodiment employs the configuration of including: acquiring, by the acquisition section 11, user data pertaining to a service which a user has received from a certain operator; determining, by the determination section 12, whether or not there is a value-added service which is receivable from a second operator in relation to the service; and generating, by the generation section 13, a message in a case where it has been determined that there is the value-added service, the message including (i) an agreement request for provision of the user data possessed by the operator to the second operator and (ii) information pertaining to the value-added service which is receivable upon approval of the user to the agreement request. In such a configuration, only a value-added service which would be favorable for the user, is timely, and is related to the primary service which the user has received is searched and provided to the user. Therefore, content of provided user data and the number of second operators to which data is provided are restricted. Therefore, according to the information processing method S1 in accordance with the first example embodiment, an additional service related to a service which a user has received is presented, and it is thus possible to bring about an example advantage of reducing an amount of information presented to the user and easily obtaining agreement from the user to use user data.

### Configuration of Information Processing System 2

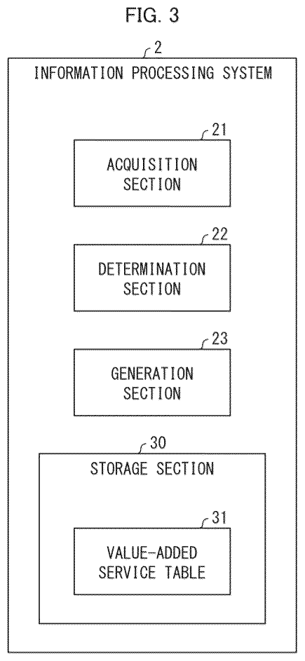

Next, the following description will discuss an information processing system 2 in accordance with the first example embodiment, with reference to the drawings. FIG. 3 is a block diagram illustrating a configuration of the information processing system 2. As illustrated in FIG. 3, the information processing system 2 includes an acquisition section 21, a determination section 22, a generation section 23, and a storage section 30.

The acquisition section 21, the determination section 22, and the generation section 23 have functions identical with those of the acquisition section 11, the determination section 12, and the generation section 13 which have been described for the information processing apparatus 1 above. Therefore, descriptions of such functions are omitted here. Note that the sections of the information processing system 2 do not need to be included in a single housing. At least some of the sections may be disposed at a different place and the sections may be connected to each other so that information communication can be carried out with each other. At least some of the sections of the information processing system 2 may be disposed on a cloud.

The storage section 30 may store user data acquired by the acquisition section 21. The storage section 30 may store various kinds of data tables used in determination carried out by the determination section 22 and various kinds of data necessary for a message generated by the generation section 23. In the first example embodiment, the storage section 30 stores, for example, a value-added service table. Details of various kinds of tables which may be stored in the storage section 30 will be described later.

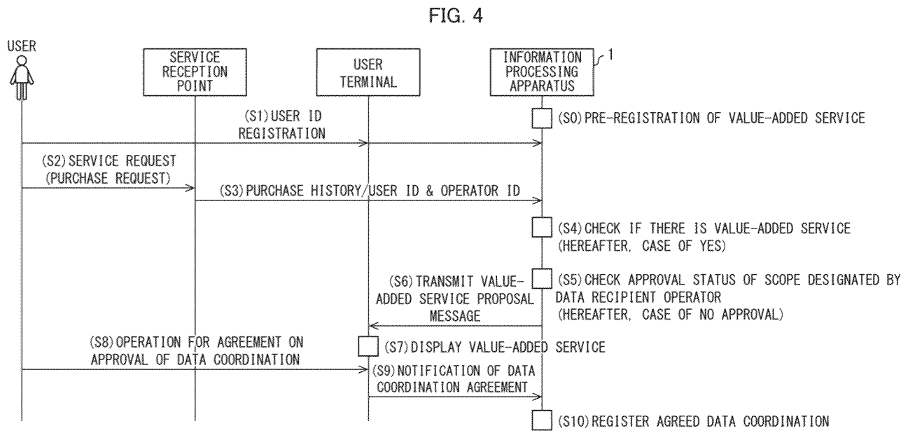

Next, a specific example of information processing which is carried out by the information processing apparatus 1 or the information processing system 2 (hereinafter, these are collectively referred to as “information processing apparatus 1” in the present example embodiment) will be described with reference to the drawings. Hereinafter, a service which the information processing apparatus 1 carries out is referred to as an “added value provision service”. The following description will discuss a flow and content of the added value provision service, with reference to the drawings. FIG. 4 is a schematic diagram illustrating a flow of the added value provision service and content of steps which are carried out by the information processing apparatus 1.

Before the information processing apparatus 1 carries out the added value provision service, a data recipient operator registers, in the information processing apparatus 1 in advance, a value-added service that is to be provided using data provided from a data provider operator together with a scope of use (step S0). By registering a value-added service in the information processing apparatus 1, each of operators can gain an opportunity to provide a value-added service related to a service which another operator has provided. That is, due to an increase in opportunity in which a user uses value-added services of the operators, the operators can mutually receive economic benefits.

A user who intends to receive the added value provision service first registers a user ID and user attributes (such as name, mail address) using a user terminal in the information processing apparatus 1 (step S1). The information processing apparatus 1 records the user ID and the user attributes in association with each other in a user table 306 (described later) in the storage section 30.

Upon completion of the registration step S1, the user can receive the added value provision service. The user first receives a primary service (step S2). A type of the primary service is not limited. Here, it is assumed that the user has done shopping at a certain supermarket (purchase request). Payment for the purchase is assumed to be made by using a card via a POS terminal. A place (supermarket) where the primary service has been received is referred to as a service reception point. When the payment for the purchase has been made by the card, card information thereof (user attribute) is transmitted to the information processing apparatus 1 (step S3). Moreover, information (purchase history information) of the purchased article and information (operator ID) of an operator that operates the service reception point are also transmitted to the information processing apparatus 1. The acquisition section 11 of the information processing apparatus 1 acquires such pieces of information.

Next, the determination section 12 of the information processing apparatus 1 determines whether or not there is a value-added service which can be provided to this user. The determination section 12 determines, with reference to the value-added service table 301 stored in the storage section 30, whether or not there is a value-added service which can be provided to this user (step S4). Specifically, the determination section 12 first determines whether or not there is a data recipient operator ID which is associated with the operator ID obtained in step S3. In a case where there is a data recipient operator ID, it is determined that there is a value-added service which can be provided.

In a case where the determination section 12 has determined in step S4 that there is no value-added service which can be provided to this user, the information processing apparatus 1 ends the added value provision service. Here, the following description will discuss various kinds of tables stored in the storage section 30. A case in which the information processing apparatus 1 has determined in step S4 that there is a value-added service which can be provided to this user will be described later.

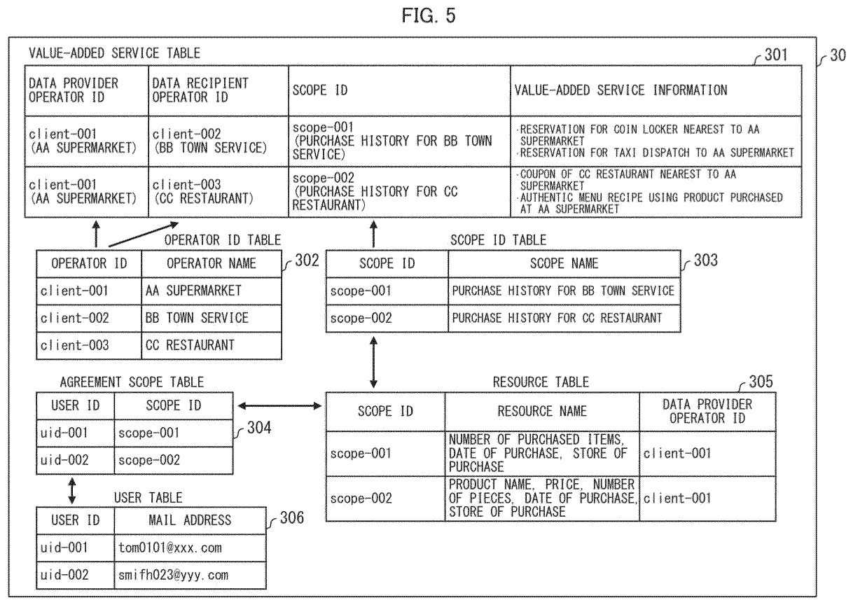

FIG. 5 is a schematic diagram illustrating content of various kinds of tables stored in the storage section 30 of the information processing apparatus 1. As illustrated in FIG. 5, the storage section 30 stores a value-added service table 301, an operator ID table 302, a scope ID table 303, an agreement scope table 304, a resource table 305, and a user table 306. These tables can be updated.

The value-added service table 301 is a data table in which information (data provider operator ID) for identifying an operator that provides user data, information (data recipient operator ID) for identifying a second operator that provides a value-added service, information (scope ID) pertaining to provision user data to be provided to the second operator, and information (value-added service information) pertaining to the value-added service are associated with each other.

The data provider operator ID is one of operator IDs, and is identification information of an operator that possesses data of a primary service which the user has received. In the example illustrated in FIG. 5, an identification number “client-001” indicating an AA supermarket is stored.

The data recipient operator ID is one of operator IDs, and is identification information of an operator that provides a secondary service which can be received in relation to the primary service. In the example illustrated in FIG. 5, an identification number “client-002” indicating a BB town service company is stored.

The scope ID is user data of the primary service which is provided to the operator that provides the secondary service. In the example illustrated in FIG. 5, an identification number “scope-001” indicating purchase history data for the BB town service company is stored. The data of the primary service does not need to be an entire part of the data and may be a part of the data. This is because the operator that provides the secondary service does not necessarily need all pieces of data of the primary service. Moreover, there is an advantage that agreement of the user would be obtained more easily if an amount of data of the primary service to be provided to the operator that provides the secondary service is small. That is, the scope ID may be data which is selected from the user data and is only data to be provided to the second operator.

The value-added service information indicates specific content of the secondary service that can be provided to the user. In the example illustrated in FIG. 5, two pieces of value-added service information “coin locker nearest to AA supermarket” and “reservation for taxi dispatch to AA supermarket” are stored.

The above data set, i.e., the data provider ID, the data recipient ID, the scope ID, and the value-added service information are stored in the storage section 30 in association with each other. Hereinafter the data set indicated in a table form means that pieces of data are stored in the storage section 30 in association with each other, and a data structure type thereof is not limited to a particular one.

The value-added service table 301 illustrated in FIG. 5 stores another data set. Specifically, a data provider ID “client-001” indicating the same AA supermarket, a data recipient ID “client-003” indicating a CC restaurant, a scope ID “scope-002” indicating purchase history data for the CC restaurant, and pieces of value-added service information “coupon of CC restaurant nearest to AA supermarket” and “authentic menu recipe using product purchased at AA supermarket” are stored in association with each other.

As such, in the value-added service table 301, secondary service information that is expected to be favorable for the user who has received the primary service is stored in association with a data set including the data provider information, the data recipient information, and the data provision scope (scope information). This data set can be a plurality of data sets.

The tables other than the value-added service table 301 are as follows. The sections of the information processing apparatus 1 carry out various kinds of data processing with reference to the value-added service table 301 and the following tables.

The operator ID table 302 is a table in which an operator ID that provides a service and an operator name of the operator are recorded in association with each other.

The scope ID table 303 indicates, by catalog definition, which data item is to be provided from the data provider to the data recipient. That is, the scope ID table 303 is a table in which a scope ID and a destination operator to which the scope ID is provided are recorded in association with each other.

The resource table 305 is a table in which a scope ID, a resource name (user data item) included in the scope ID, and a data provider operator ID are recorded in association with each other.

The user table 306 is a table in which a user ID and personal information of the user (in particular, a mail address or a telephone number which is a notification destination of a message) are recorded in association with each other.

The agreement scope table 304 is a table in which a user ID and a scope ID for which the user has agreed with provision are recorded in association with each other. The agreement scope table 304 holds, as a table, a user approval result with respect to a data coordination agreement request presented from the information processing apparatus 1. The agreement scope table 304 can record only a scope ID for which the user has made agreement, or can record scope IDs including a scope ID for which the user has not made agreement. In step S4 described above, the information processing apparatus 1 determines, with reference to this agreement scope table 304, whether or not there is a value-added service which can be provided.

Returning to FIG. 4, a case will be described in which the determination section 12 has determined in step S4 that there is a value-added service which can be provided to this user. The value-added service table 301 includes value-added service information which can be provided to a user who has done shopping at the AA supermarket. Therefore, the information processing apparatus 1 determines that there is a value-added service which can be provided to this user. Next, the determination section 12 determines whether or not agreement on provision of user data which is possessed by the operator (AA supermarket) of the primary service and is in a data provision scope specified by a recipient operator to the second operator has already been obtained from this user (step S5). The agreement scope table 304 illustrated in FIG. 5 stores content of user data for which agreement on data coordination has been obtained from the user. The information processing apparatus 1 carries out the determination in step S5 with reference to this agreement scope table 304.

In step S5, in a case where it has been determined that agreement to provide the data provision scope to the second operator has already been obtained from the user, the information processing apparatus 1 carries out an added value provision service. The added value provision service, as described later, is to transmit and present, to the user, content of a secondary service which is available to the user. Hereinafter, a case will be described in which the information processing apparatus 1 has determined in step S5 that agreement to provide the data provision scope to the second operator has not been obtained yet from the user.

In a case where it has been determined in step S5 that agreement has not been obtained from the user yet, the generation section 13 of the information processing apparatus 1 generates a message including information pertaining to a value-added service. The generated message is transmitted to the user terminal via the communication section 40 (step S6). The transmitted message is displayed on the user terminal (step S7). With such a configuration, an agreement request is sent to the user only when data coordination has not yet been agreed. Therefore, it is possible to eliminate the need for the user to repeatedly make agreement.

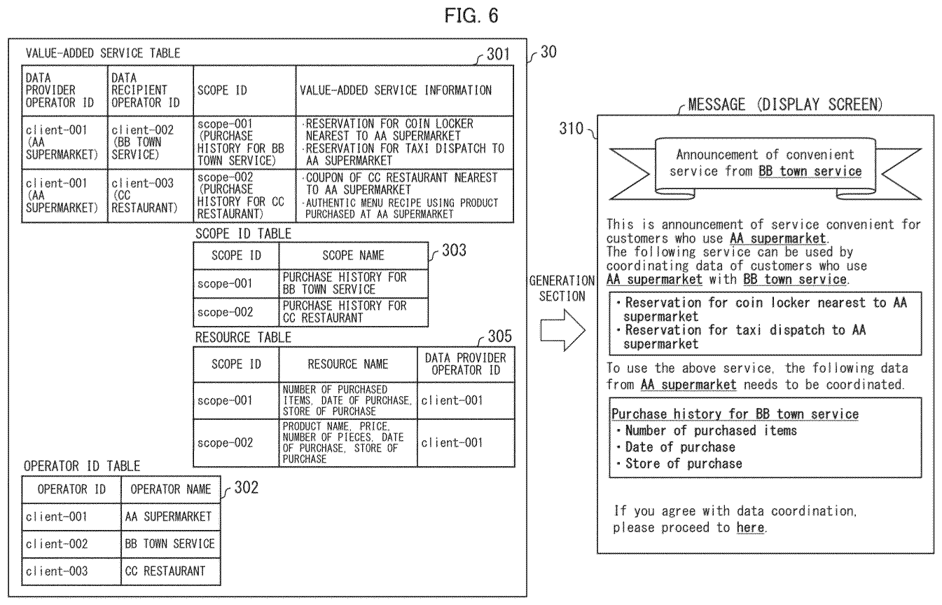

Next, an example of a message generated and displayed will be described with reference to the drawings. FIG. 6 is a schematic diagram illustrating a procedure for generating a message by the generation section 23 and an example of the message. The generation section 23 acquires, from the value-added service table 301, value-added service information “reservation for coin locker, reservation for taxi dispatch”. In 2nd row of the value-added service table 301, an operator ID of an operator from which the user has used the primary service is “client-001”. Therefore, the generation section 23 acquires “AA supermarket”, which is an operator name of “client-001”, with reference to the operator ID table 302. An operator ID of the data recipient in 2nd row is “client-002”. Therefore, the generation section 23 acquires “BB town service”, which is an operator name of “client-002”, with reference to the operator ID table 302. The scope of the user data in 2nd row which is requested by the “BB town service” is “scope-001”. Therefore, the generation section 23 acquires information “number of purchased items, date of purchase, and store of purchase”, which is a resource name of “scope-001”, with reference to the resource table 305.

The generation section 23 generates a message (display screen) 310 based on information acquired as described above. The message 310 is a schematic diagram of an image indicating a state of being displayed on a screen of the user terminal in step S7. The message 310 includes an operator (AA supermarket) from which the user has received the primary service, content of a value-added service (secondary service) which the user can receive (reservation for coin locker, reservation for taxi dispatch), an operator name (BB town service) that provides the secondary service, content of primary service data which is agreed to be provided to the secondary service operator in order to receive the secondary service. Examples of the message 310 include sentences such as “This is announcement of service convenient for customers who use AA supermarket”, “The following service can be used by coordinating data of customers who use AA supermarket with BB town service (omit the rest)”, “To use the above service, the following data from AA supermarket needs to be coordinated (omit the rest)”. Then, in a case where the user makes agreement, an invitation sentence with hyperlink for moving to a screen on which an agreement procedure is to be carried out is displayed at the end.

Note that, in a case where it has been determined in step S5 that agreement to provide the data provision scope to the second operator has already been obtained from the user, the generation section 23 may generate only an invitation to the secondary service. That is, the generation section 23 does not need to generate an operator name (BB town service) that provides the secondary service, content of the primary service data which is agreed to be provided to the secondary service operator in order to receive the secondary service, and an invitation sentence for moving to a screen on which the agreement procedure is carried out in a case where the user makes agreement.

The generation of the above message has been described for data in 2nd row in the value-added service table 301. The data in 3rd row can be generated in a similar manner. In this case, the generation section 23 generates two types of value-added service information and transmits the two types of value-added service information to the user terminal. The plurality of types of value-added service information may be displayed in a single screen or may be displayed separately in a plurality of screens.

Returning to FIG. 4, an operation in which the user makes agreement on provision of data is carried out by the user terminal (step S8), and then a data coordination agreement notification is transmitted from the user terminal to the information processing apparatus 1 (step S9). The information processing apparatus 1 updates the agreement scope table 304 by associating the agreed data coordination information with the scope ID and the user ID (step S10).

A data type for acquiring agreement can be defined by a data set called “Scope” that is used in OAuth 2.0 [RFC6749] Section 3.3. According to this data set, it is possible to make fine settings in accordance with needs of consumers. For example, in defining product purchase data, specific examples include separately defining food purchase data and medical product purchase data.

In a case where the user has agreed with data coordination, the user can receive a value-added service that is provided by an operator of the data coordination destination. For example, in the above example, it is possible to reserve use of a coin locker and/or reserve dispatch of a taxi. The user can obtain convenient options such as depositing belongings of shopping in a coin locker and returning home by a taxi, and can thus obtain a feeling of satisfaction. When the user has obtained such a feeling of satisfaction, the user positively considers data coordination for the other pieces of user data. Therefore, it is possible to facilitate user data coordination.

### Example Advantage of Information Processing System 2

In the information processing system 2 having the above configuration also, it is possible to bring about an example advantage similar to the example advantage brought about by the information processing apparatus 1 and the information processing method S1 described above.

### Second Example Embodiment

The following description will discuss a second example embodiment of the present invention in detail with reference to the drawings. The same reference numerals are given to constituent elements which have functions identical with those described in the first example embodiment, and descriptions as to such constituent elements are omitted as appropriate.

### Configuration of Information Processing Apparatus 1A

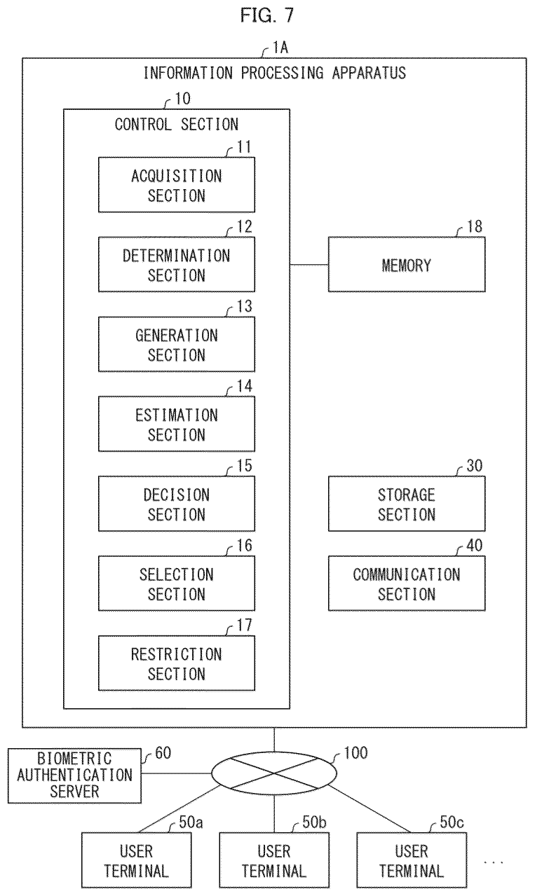

FIG. 7 is a block diagram illustrating a configuration of an information processing apparatus 1A in accordance with the present example embodiment. As illustrated in FIG. 7, the information processing apparatus 1A includes a control section 10, a storage section 30, and a communication section 40. The information processing apparatus 1A is connected to a biometric authentication server (face authentication apparatus) 60 such that information communication can be carried out with each other.

The control section 10 includes an acquisition section 11, a determination section 12, a generation section 13, an estimation section 14, a decision section 15, a selection section 16, a restriction section 17, and a memory 18.

The control section 10 controls the entire information processing apparatus 1A. The control section 10 can be configured, for example, using at least one general-purpose processor such as a micro processing unit (MPU) and a central processing unit (CPU). The control section 10 may include a dedicated processor that is configured by an application specific integrated circuit (ASIC), a field programmable gate array (FPGA), a programmable logic device (PLD), or the like. The memory 18 may include a plurality of types of memories such as a read only memory (ROM) and a random access memory (RAM). The memory 18 may include a built-in or external memory such as a hard disk drive (HDD) or a solid state drive (SSD). For example, the control section 10 loads various control programs stored in the ROM of the memory 18 into the RAM and executes the programs to realize the functions as the acquisition section 11, the determination section 12, the generation section 13, the estimation section 14, the decision section 15, the selection section 16, and the restriction section 17.

The acquisition section 11, the determination section 12, and the generation section 13 have functions to those of the acquisition section 11, the determination section 12, and the generation section 13 which have been described for the information processing apparatus 1 above. Therefore, descriptions f such functions are omitted here. Functions of the estimation section 14, the decision section 15, the selection section 16, and the restriction section 17 will be described in the following example embodiment.

The storage section 30 may store user data acquired by the acquisition section 11. The storage section 30 may store various data tables used in determination carried out by the determination section 12 and various data tables necessary for a message generated by the generation section 13. As described for the information processing system 2 above, the storage section 30 stores, for example, a value-added service table. Details of other pieces of information which may be stored in the storage section 30 will be described below as appropriate.

The communication section 40 is an interface that communicates (i.e., carries out transmission and reception of data) with a plurality of user terminals 50 (50a, 50b, 50c, . . . ). The user terminal 50 is a POS terminal or the like of an operator. Communication between the communication section 40 and the plurality of user terminals 50 can be carried out via, for example, the Internet 100. In such a case, the communication section 40 may include, for example, a short-range communication apparatus such as WiFi (registered trademark) or Bluetooth (registered trademark) that enables wireless connection to a connection point of the Internet 100.

The information processing apparatus 1A is connected to the biometric authentication server 60 such that information communication can be carried out with each other via the Internet 100. The biometric authentication server 60 is a system that authenticates, using biometric information of a user, whether or not the user is the same person as a pre-registered user. The biometric authentication server 60 (i) extracts a feature quantity from sensor information acquired by a biometric authentication sensor, (ii) generates a biometric authentication data ID as identification information for the feature quantity, and (iii) manages the biometric authentication data ID in association with the feature quantity.

The biometric information used is not particularly limited, and may be face authentication which has advantages as follows: that is, it is possible to acquire information in a non-contact manner, it is possible to obtain information by a simple apparatus, the face authentication can identify a user with relatively high accuracy, and the like. In the case of using the face authentication, the biometric authentication server 60 extracts a feature quantity of a face from a face image acquired by a camera or the like, adds a face ID thereto, and manages the face feature quantity in association with the face ID. A data table including authentication data including the face ID is referred to as a face ID table. By carrying out user authentication using a face authentication system, user convenience can be further improved.

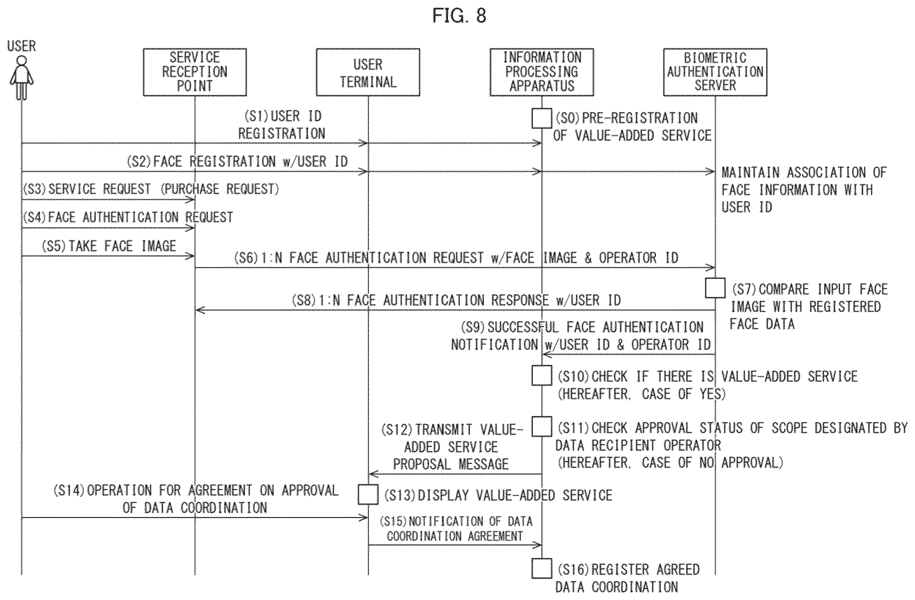

The information processing apparatus 1A is an apparatus that provides an added value provision service. The following description will discuss a flow and content of the added value provision service, with reference to the drawings. FIG. 8 is a schematic diagram illustrating a flow of the added value provision service and content of steps which are carried out by the information processing apparatus 1A. The flow of the added value provision service which is carried out by the information processing apparatus 1A is basically the same as the flow of the added value provision service described in the first example embodiment. The following description will mainly discuss characteristic parts in the present example embodiment, and descriptions of the other parts will be omitted.

Before the information processing apparatus 1A carries out the added value provision service, a data recipient operator registers, in the information processing apparatus 1A in advance, a value-added service that is to be provided using data of a data provider operator together with a scope of use (step S0). The reason for this is as described in the first example embodiment.

A user who intends to receive the added value provision service first registers a user ID and user attributes (such as name, mail address) using a user terminal in the information processing apparatus 1A (step S1). The user attributes and the registration method thereof are as described in the first example embodiment. In the present example embodiment, the user information includes face authentication data (face information) of the user. Therefore, the user ID and the face information of the user are registered also in the biometric authentication server 60 (step S2).

For example, in a case where the information processing apparatus 1A is connected to a POS terminal or a registration-specific terminal with a camera, the information processing apparatus 1A acquires card information read by the POS terminal and a face image acquired by the camera. The information processing apparatus 1A transmits the face image of the user together with the user ID to the biometric authentication server 60. The biometric authentication server 60 associates the face information with the user ID and thus carries out user registration. After that, the information processing apparatus 1A carries out an added value provision service using user authentication which is carried out by the biometric authentication server 60. The user may make payment for a service which the user has received by electronic payment with face authentication. Thus, the user can receive various kinds of services without needing use of either cash or a card.

Upon completion of step S1 and step S2, the user can receive the added value provision service. The user first receives a primary service (step S3). Here, it is assumed that the user has done shopping at a certain supermarket (purchase request).

The user requests the information processing apparatus 1A for face authentication (step S4). Then, the user is prompted by the information processing apparatus 1A to take a face image. Then, the user stands in front of the camera, and the POS terminal takes a face image (step S5) and transmits the face image to the biometric authentication server 60 together with an operator ID and a user ID (step S6). The biometric authentication server 60 compares the transmitted face image with the registered face information to carry out user authentication (step S7). In a case where the face authentication is successful, the biometric authentication server 60 transmits this fact together with the user ID to the POS terminal (step S8). At this time, electronic payment for an article purchased by the user is also carried out. The biometric authentication server 60 transmits, together with the user ID and the operator ID, the fact that face authentication has been successful to the information processing apparatus 1A (step S9).

Next, the information processing apparatus 1A confirms whether or not there is a value-added service which can be provided to this user (step S10). Steps S10 through S16 here are similar to steps S4 through S10 of the added value provision service described in the first example embodiment. Therefore, descriptions thereof are omitted here. Configurations of various kinds of tables stored in the storage section 30 of the information processing apparatus 1A are also similar to the tables illustrated in FIG. 5 described in the first example embodiment.

### Estimation Section 14

As illustrated in FIG. 7, the information processing apparatus 1A may include an estimation section 14 that estimates a user satisfaction level with respect to a value-added service. In a case where a large number of types of secondary services are registered, it is not favorable to transmit, to a user, a message including content of all the secondary services. This is because there is a risk that a message including a large amount of information would reduce will of the user to read such a message. The estimation section 14 estimates a satisfaction level of a user with respect to each of a plurality of value-added services.

The estimation section 14 may estimate a user satisfaction level based on a geographical relation between a place where the user has received the service from the operator and a place where the user can receive the value-added service. The user typically receives value-added service information at a place where the user has received the service. Therefore, in a case where, for example, a place where a service has been received is far from a place where a value-added service can be received, or a place where a value-added service can be received is a place that is geographically difficult to reach and it takes time to reach the place, a satisfaction level is considered to be low. That is, the satisfaction level of the user can be considered to increase if a distance to a place where a value-added service can be received is shorter and it is geographically easy to reach the place.

Alternatively, in a case where the information processing apparatus 1A stores action information of the user, the estimation section 14 may estimate a user satisfaction level based on the action information of the user. The action information can be, for example, a record of services which the user has received. For example, a place where the user frequently visits is a place reflecting preference of the user. If a value-added service can be received at such a place, a satisfaction level of the user is considered to be high. In contrast, a satisfaction level of a value-added service that can be received at a place where the user hardly visits is considered to be low. As such, by presenting a value-added service suitable for each user based on an action history of that user, it is possible to increase a feeling of satisfaction of the user, as well as facilitate user data coordination.

### Decision Section 15

Therefore, the information processing apparatus 1A can further include a decision section 15 that decides, based on the user satisfaction level, a value-added service to be included in the message. The decision section 15 may decide a predetermined number of value-added services with higher satisfaction levels among value-added services which can be provided to the user and which have been estimated by the estimation section 14. The generation section 13 generates a message including the decided value-added service. As such, it is considered that preferentially introducing to the user a value-added service for which a satisfaction level of the user is estimated to be high can be useful in facilitating agreement of the user on data coordination.

### Selection Section 16

The information processing apparatus 1A can further include a selection section 16 that selects, from the user data for each second operator, provision user data (resource) to be provided to that second operator. The selection section 16 selects, based on a pattern table, a type of user data which is considered to be needed by a certain operator. Here, the pattern table includes a plurality of combination patterns of business categories of operators and types of user data needed according to the business categories. Thus, even in a case where a large number of operators have been registered, it is possible to prepare resource tables needed by the respective operators. Alternatively, the selection section 16 may select provision user data to be provided to a second operator in accordance with a data set called “Scope” used in the foregoing OAuth 2.0 [RFC6749] Section 3.3.

The generation section 13 may configure a message to be generated such that user data provided to a second operator and information pertaining to a value-added service to be received are displayed in a single display screen. Display in a single display screen means that the user can read and determine a main part of a message without scrolling or turning over pages. For example, the message (display screen) 310 illustrated in FIG. 6 is configured such that user data (purchase history for BB town service) to be provided to the second operator and information (reservation for nearest coin locker, reservation for taxi dispatch to AA supermarket) pertaining to the value-added service to be received are displayed in a single display screen.

In many cases, for a businesslike message with too much information or a businesslike message that is a plurality of pages in length, will of the user to read such a message is reduced. Therefore, it is preferable to compose a message which is as compact and easy to see as possible. By configuring a message such that user data provided to the second operator and information pertaining to the value-added service which is receivable are displayed in a single display screen, it is possible to make the user have will to read such a message.

### Restriction Section 17

The information processing apparatus 1A can further include a restriction section 17 that restricts the number of value-added services which can be received and which are included in a message. In many cases, for a businesslike message with much information, will of the user to read such a message is reduced. By restricting the number of value-added services which can be received, it is possible to make the user have will to read a message. The number of value-added services to be displayed is preferably set to approximately one or two. A method of selecting a restricted number of value-added services may be a method of selecting from value-added services which have been decided by the decision section 15.

### Example Advantage of Information Processing Apparatus 1A

As described above, the information processing apparatus 1A in accordance with the present example embodiment employs the configuration in which user authentication is carried out using the face authentication apparatus 60. Therefore, according to the information processing apparatus 1A in accordance with the present example embodiment, it is possible to bring about an example advantage of easily carrying out authentication of the user with a simple configuration, i.e., a camera, and thus improving convenience of the user, in addition to the example advantage brought about by the information processing apparatus 1 in accordance with the first example embodiment.

The information processing apparatus 1A in accordance with the present example embodiment employs the configuration of further including the estimation section 14 that estimates a user satisfaction level with respect to a value-added service. Moreover, employed is the configuration of further including the decision section 15 that decides a value-added service to be included in the message based on the estimated user satisfaction level. Therefore, according to the information processing apparatus 1A in accordance with the present example embodiment, it is possible to bring about an example advantage of proposing a value-added service for which a satisfaction level of the user is high, in addition to the example advantage brought about by the information processing apparatus 1 in accordance with the first example embodiment.

The information processing apparatus 1A in accordance with the present example embodiment employs the configuration of further including the selection section 16 which selects, from the user data for each second operator, provision user data (resource) to be provided to that second operator. Therefore, according to the information processing apparatus 1A in accordance with the present example embodiment, it is possible to bring about an example advantage that, even in a case where a large number of operators have been registered, a resource table needed by each of the operators can be prepared, in addition to the example advantage brought about by the information processing apparatus 1 in accordance with the first example embodiment.

The information processing apparatus 1A in accordance with the present example embodiment employs the configuration in which the generation section 13 configures a message to be generated such that user data provided to a second operator and information pertaining to a value-added service to be received are displayed in a single display screen. Therefore, according to the information processing apparatus 1A in accordance with the present example embodiment, it is possible to bring about an example advantage of making a user have will to read the message, in addition to the example advantage brought about by the information processing apparatus 1 in accordance with the first example embodiment.

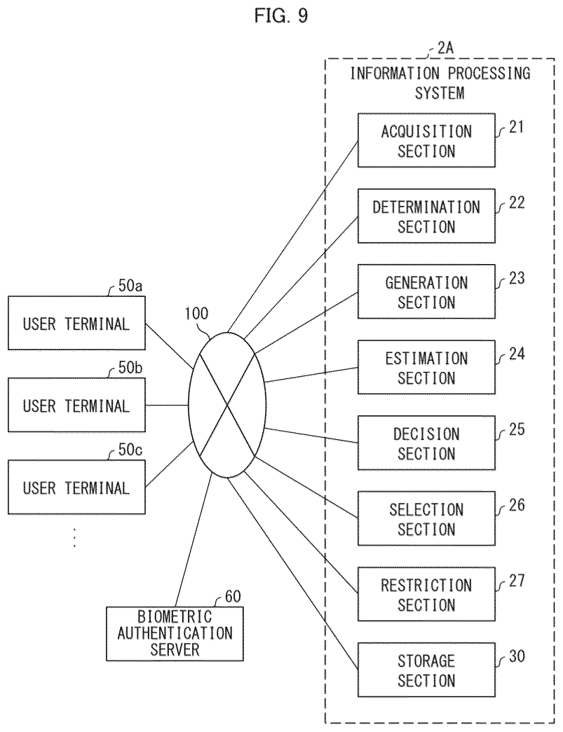

FIG. 9 is a block diagram illustrating a configuration of an information processing system 2A in accordance with the present example embodiment. As illustrated in FIG. 9, the information processing system 2A includes an acquisition section 21, a determination section 22, a generation section 23, an estimation section 24, a decision section 25, a selection section 26, a restriction section 27, and a storage section 30. At least some of these sections can be connected to each other such that information communication can be carried out via the Internet 100. At least some of these sections can be disposed on a cloud.

The information processing system 2A can carry out information communication with a plurality of user terminals 50 (50a, 50b, 50c, . . . ) via the Internet 100. The information processing system 2A can further carry out information communication with the biometric authentication server 60.

The functions of the acquisition section 21, the determination section 22, the generation section 23, the estimation section 24, the decision section 25, the selection section 26, the restriction section 27, the storage section 30, and the biometric authentication server 60 are the same as those of the acquisition section 11, the determination section 12, the generation section 13, the estimation section 14, the decision section 15, the selection section 16, the restriction section 17, the storage section 30, and the biometric authentication server 60 which have been described for the information processing apparatus 1A. Therefore, descriptions of such functions are omitted here.

### Example Advantage of Information Processing System 2A

According to the information processing system 2A in accordance with the present example embodiment, it is possible to bring about an example advantage similar to the example advantage brought about by the information processing apparatus 1A.

### Software Implementation Example

The functions of part of or all of the information processing apparatus (1, 1A) and the information processing system (2, 2A) (hereinafter referred to as “information processing apparatus 1, and the like”) can be realized by hardware such as an integrated circuit (IC chip) or can be alternatively realized by software.

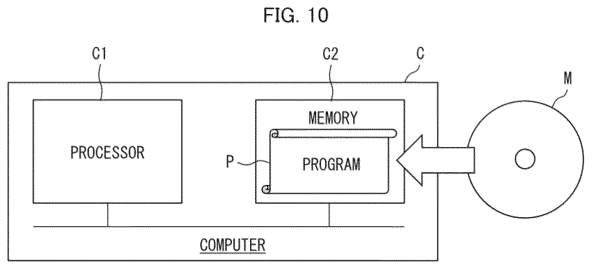

In the latter case, each of the information processing apparatus 1, and the like is realized by, for example, a computer that executes instructions of a program that is software realizing the foregoing functions. FIG. 10 illustrates an example of such a computer (hereinafter, referred to as “computer C”). The computer C includes at least one processor C1 and at least one memory C2. The memory C2 stores a program P for causing the computer C to function as the information processing apparatus 1, and the like. In the computer C, the processor C1 reads the program P from the memory C2 and executes the program P, so that the functions of the information processing apparatus 1, and the like are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. Examples of the memory C2 include a flash memory, a hard disk drive (HDD), a solid state drive (SSD), and a combination thereof.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some or all of the foregoing example embodiments can also be described as below. Note, however, that the present invention is not limited to the following supplementary notes.

### Supplementary Note 1

An information processing apparatus, including: an acquisition means for acquiring user data pertaining to a service which a user has received from an operator; a determination means for determining whether or not there is a value-added service which is receivable from a second operator in relation to the service; and a generation means for generating a message in a case where it has been determined that there is the value-added service, the message including (i) an agreement request for provision of the user data possessed by the operator to the second operator and (ii) information pertaining to the value-added service which is receivable upon approval of the user to the agreement request.

According to the above configuration, an additional service related to a service which a user has received is presented, and it is thus possible to reduce an amount of information presented to the user and easily obtain agreement from the user to use user data.

### Supplementary Note 2

The information processing apparatus according to supplementary note 1, in which: the determination means further determines whether or not agreement on provision of the user data possessed by the operator to the second operator has already been obtained from the user; and in a case where it has been determined that the agreement has not been obtained from the user, the generation means generates the message.

According to the above configuration, an agreement request is sent to the user only when data coordination has not yet been agreed. Therefore, it is possible to eliminate the need for the user to repeatedly make agreement.

### Supplementary Note 3

The information processing apparatus according to supplementary note 1 or 2, further including: an estimation means for estimating a user satisfaction level with respect to the value-added service.

According to the above configuration, it is possible to select a value-added service with a high user satisfaction level.

### Supplementary Note 4

The information processing apparatus according to supplementary note 3, in which: the user satisfaction level is estimated based on a geographical relation between a place where the user has received the service from the operator and a place where the user receives the value-added service, or based on action information of the user.

According to the above configuration, it is possible to select a value-added service that can be received at a place nearby in terms of distance or time. Thus, it is possible to select a value-added service with a high user satisfaction level.

### Supplementary Note 5

The information processing apparatus according to supplementary note 3 or 4, further including: a decision means for deciding, based on the user satisfaction level, a value-added service to be included in the message.

According to the above configuration, it is possible to restrict the number of value-added services presented to the user. Thus, the user can easily carry out data coordination.

### Supplementary Note 6

The information processing apparatus according to any one of supplementary notes 1 through 5, further including: a selection means for selecting, from the user data for each second operator, provision user data to be provided to the second operator.

According to the above configuration, it is possible to restrict user data to be provided to a second operator.

### Supplementary Note 7

The information processing apparatus according to any one of supplementary notes 1 through 6, in which: the message is configured such that user data provided to the second operator and information pertaining to the value-added service which is receivable are displayed in a single display screen.

According to the above configuration, a user can easily determine presented information.

### Supplementary Note 8

An information processing method, including: acquiring, by at least one processor, user data pertaining to a service which a user has received from an operator; determining, by the at least one processor, whether or not there is a value-added service which is receivable from a second operator in relation to the service; and generating, by the at least one processor, a message in a case where it has been determined that there is the value-added service, the message including (i) an agreement request for provision of the user data possessed by the operator to the second operator and (ii) information pertaining to the value-added service which is receivable upon approval of the user to the agreement request.

According to the above configuration, it is possible to bring about an example advantage similar to the example advantage brought about by the information processing apparatus according to supplementary note 1.

### Supplementary Note 9

An information processing system, including: an acquisition means for acquiring user data pertaining to a service which a user has received from an operator; a determination means for determining whether or not there is a value-added service which is receivable from a second operator in relation to the service; a generation means for generating a message in a case where it has been determined that there is the value-added service, the message including (i) an agreement request for provision of the user data possessed by the operator to the second operator and (ii) information pertaining to the value-added service which is receivable upon approval of the user to the agreement request; and a storage section for storing a value-added service table in which information pertaining to the operator, information pertaining to the value-added service, information pertaining to the second operator that provides the value-added service, and information pertaining to provision user data to be provided to the second operator are recorded in association with each other.

According to the above configuration, it is possible to bring about an example advantage similar to the example advantage brought about by the information processing apparatus according to supplementary note 1.

### Supplementary Note 10

An information processing program for causing a computer to carry out: an acquisition process of acquiring user data pertaining to a service which a user has received from an operator; a determination process of determining whether or not there is a value-added service which is receivable from a second operator in relation to the service; and a generation process of generating a message in a case where it has been determined that there is the value-added service, the message including (i) an agreement request for provision of the user data possessed by the operator to the second operator and (ii) information pertaining to the value-added service which is receivable upon approval of the user to the agreement request.

According to the above configuration, it is possible to bring about an example advantage similar to the example advantage brought about by the information processing apparatus according to supplementary note 1.

### Supplementary Note 11

The information processing apparatus according to any one of supplementary notes 1 through 7, further including: a restriction means for restricting the number of value-added services which are receivable and included in the message.

According to the above configuration, a user can easily determine presented information.

### Supplementary Note 12

The information processing apparatus according to any one of supplementary notes 1 through 7, further including: a face authentication apparatus that carries out authentication of the user using a face image of the user.

According to the above method, it is possible to further enhance convenience of the user.

### Supplementary Note 13

An information processing apparatus according to any one of supplementary notes 1 through 7, further including: a storage section for storing a value-added service table in which information pertaining to the operator, information pertaining to the value-added service, information pertaining to the second operator that provides the value-added service, and information pertaining to provision user data to be provided to the second operator are recorded in association with each other.

### Supplementary Note 14

The information processing system according to supplementary note 9, in which: the storage section includes an agreement scope table in which a user ID and the user data for which the user has agreed with coordination are recorded in association with each other.

### Supplementary Note 15

The information processing system according to supplementary note 9, in which: the storage section stores a scope ID table for recording provision user data which has been selected from the user data and which is to be provided to the second operator.

### Supplementary Note 16

An information processing program for causing a computer to operate as the information processing apparatus according to any one of supplementary notes 1 through 7, the information processing program causing the computer to function as the means.

### Additional Remark 3

Furthermore, some of or all of the foregoing example embodiments can also be expressed as below.

An information processing apparatus, including at least one processor, the at least one processor carrying out: an acquisition process of acquiring user data pertaining to a service which a user has received from an operator; a determination process of determining whether or not there is a value-added service which is receivable from a second operator in relation to the service; and a generation process of generating a message in a case where it has been determined that there is the value-added service, the message including (i) an agreement request for provision of the user data possessed by the operator to the second operator and (ii) information pertaining to the value-added service which is receivable upon approval of the user to the agreement request.

Note that the information processing apparatus can further include a memory. The memory can store a program for causing the at least one processor to carry out the acquisition process, the determination process, and the generation process. The program can be stored in a computer-readable non-transitory tangible storage medium.

### REFERENCE SIGNS LIST

1, 1A: Information processing apparatus
10: Control section
11, 21: Acquisition section
12, 22: Determination section
13, 23: Generation section
14, 24: Estimation section
15, 25: Decision section
16, 26: Selection section
17, 27: Restriction section
2, 2A: Information processing system
30: Storage section
40: Communication section
50: User terminal
60: Biometric authentication server

1. An information processing apparatus, comprising at least one processor, the at least one processor carrying out:
an acquisition process of acquiring user data pertaining to a service which a user has received from an operator;
a determination process of determining whether or not there is a value-added service which is receivable from a second operator in relation to the service; and
a generation process of generating a message in a case where it has been determined that there is the value-added service, the message including (i) an agreement request for provision of the user data possessed by the operator to the second operator and (ii) information pertaining to the value-added service which is receivable upon approval of the user to the agreement request.

2. The information processing apparatus according to claim 1, wherein:
in the determination process, the at least one processor further determines whether or not agreement on provision of the user data possessed by the operator to the second operator has already been obtained from the user; and
in a case where it has been determined that the agreement has not been obtained from the user, the at least one processor generates the message in the generation process.

3. The information processing apparatus according to claim 1, wherein:
the at least one processor further carries out an estimation process of estimating a user satisfaction level with respect to the value-added service.

4. The information processing apparatus according to claim 3, wherein:
the user satisfaction level is estimated based on a geographical relation between a place where the user has received the service from the operator and a place where the user receives the value-added service, or based on action information of the user.

5. The information processing apparatus according to claim 4, wherein:
the at least one processor further carries out a decision process of deciding, based on the user satisfaction level, a value-added service to be included in the message.

6. The information processing apparatus according to claim 1, wherein:
the at least one processor further carries out a selection process of selecting, from the user data for each second operator, provision user data to be provided to the second operator.

7. The information processing apparatus according to claim 1, wherein:
the message is configured such that user data provided to the second d operator and information pertaining to the value-added service which is receivable are displayed in a single display screen.

8. An information processing method, comprising:
acquiring, by at least one processor, user data pertaining to a service which a user has received from an operator;
determining, by the at least one processor, whether or not there is a value-added service which is receivable from a second operator in relation to the service; and
generating, by the at least one processor, a message in a case where it has been determined that there is the value-added service, the message including (i) an agreement request for provision of the user data possessed by the operator to the second operator and (ii) information pertaining to the value-added service which is receivable upon approval of the user to the agreement request.

9. An information processing system, comprising at least one processor and a memory,
the at least one processor carrying out:
an acquisition process of acquiring user data pertaining to a service which a user has received from an operator;
a determination process of determining whether or not there is a value-added service which is receivable from a second operator in relation to the service; and
a generation process of generating a message in a case where it has been determined that there is the value-added service, the message including (i) an agreement request for provision of the user data possessed by the operator to the second operator and (ii) information pertaining to the value-added service which is receivable upon approval of the user to the agreement request, and
the memory storing a value-added service table in which information to the pertaining operator, information pertaining to the value-added service, information pertaining to the second operator that provides the value-added service, and information pertaining to provision user data to be provided to the second operator are recorded in association with each other.

10. A computer-readable non-transitory storage medium storing a program for causing at least one processor to carry out an information processing method recited in claim 8.
